(19) United States
(12) Patent Application Publication
(10) Pub. No.: US 2008/0224957 A1
(43) Pub. Date: Sep. 18, 2008

(54) PLASMA DISPLAY PANEL

(76) Inventor: Dong-hyun Kim, Suwon (KR)

Correspondence Address: CHRISTIE, PARKER & HALE, LLP, PO BOX 7068, PASADENA, CA, 91109-7068, US

(21) Appl. No.: 12/044,785

(22) Filed: Mar. 7, 2008

(30) Foreign Application Priority Data
Mar. 12, 2007 (KR) 10-2007-0024006

(51) Int. Cl. G09G 3/28

(52) U.S. Cl. 345/67

(57) ABSTRACT

A plasma display panel (PDP) capable of reducing or suppressing resonance between adjacent capacitively coupled sustain electrodes, which can generate audible noise from a panel, and accordingly reducing the noise of the panel. The sustain electrodes comprise a plurality of X electrodes and a plurality of Y electrodes, which cross a substantially perpendicular plurality of address electrodes. According to one embodiment, the sustain electrodes are arranged using at least two of four different patterns of four, such as X-Y:X-Y, X-Y:Y-X, Y-X:Y-X, and Y-X:X-Y. According to another embodiment, a pattern of four adjacent electrodes is not repeated more than once.

### CROSS-REFERENCE TO RELATED APPLICATION

This application claims priority to and the benefit of Korean Patent Application No. 10-2007-0024006, filed on Mar. 12, 2007, in the Korean Intellectual Property Office, the entire content of which is incorporated herein by reference.

### BACKGROUND

1. Field of the Invention

The present invention relates to a plasma display panel (PDP), and more particularly to an arrangement of sustain electrodes in a PDP.

2. Description of the Related Art

Recently, flat panel display devices such as a liquid crystal display (LCD), a field emission display (FED), and a plasma display panel (PDP), etc., have been actively developed. Among these flat panel display devices, a PDP has advantages of higher brightness and luminous efficiency and a wider viewing angle than other flat panel display devices. PDPs are categorized as DC or AC types according to which type of driving voltage is applied to discharge cells.

FIG. 1 is a cross-sectional view of a conventional three electrode PDP cell. This PDP cell 100 includes a front substrate 101, a rear substrate 102, X and Y electrodes 103 and 104 that are alternately disposed on the lower surface of the front substrate 101, a front dielectric layer 105 burying the X and Y electrodes 103 and 104, a protective film layer 106 formed on the surface of the front dielectric layer 105, an address electrode 107 disposed on the upper surface of the rear substrate 102 and substantially perpendicular to the X and Y electrodes 103 and 104, a rear dielectric layer 108 burying the address electrode 107, a barrier rib 109 disposed between the front and the rear substrates 101 and 102 to define a discharge space, and phosphor layers 110 of red, green or blue applied in the barrier rib 109.

In order to drive such a conventional three electrode PDP, proper X and Y waveforms should be applied together with an address signal. The PDP 100 having the above structure selects a discharge cell to emit light when proper electrical signals are applied to the address electrode 107 and the Y electrode 104, and the phosphor 110 emits visible light from the selected cells when proper electrical signals are alternately applied to the X and Y electrodes 103 and 104, making it possible to implement a still picture or a moving picture. Because the X and Y electrodes are called sustain electrodes, the frequency of these signals on the X and Y electrodes is called a sustain frequency. These X and Y electrodes 103 and 104, and address electrode 107 are driven by an external circuit (not illustrated).

In an AC PDP, the front substrate 101 and the rear substrate 102 are bonded together. During operation of the PDP, the sustain frequency causes the front substrate 101 and the rear substrate 102 of the panel to vibrate and collide with each other, generating audible noise.

NTSC (named for the National Television Systems Committee) and PAL (short for Phase Alternating Line) are two systems used in different parts of the world for encoding analog video signals. FIG. 2A is a graph showing a sustain frequency of a PDP displaying an NTSC signal, and FIG. 2B is a graph showing a noise frequency of the PDP displaying the NTSC signal. FIG. 3A is a graph showing a sustain frequency of a PDP displaying a PAL signal, and FIG. 3B is a graph showing a noise frequency of the PDP displaying the PAL signal.

As shown in FIGS. 2A to 3B, after analyzing the correlation between each detailed waveform and the noise of the PDP, it is noted that a sustain waveform closely conforms to a noise frequency at the NTSC frequency and the PAL frequency. Specifically, Table 1 shows peak noise frequencies and driving waveform frequencies in NTSC and PAL schemes. It can be appreciated that the noise frequencies and the driving waveform frequencies in the NTSC and PAL schemes conform to each other.

TABLE 1

| | NTSC | | PAL | |
|---|---|---|---|---|
| | A.C. (Noise) | Sustain | A.C. (Noise) | Sustain |
| 1^{st} peak | 1.14 kHz | 1.14 kHz | 1.15 kHz | 1.16 kHz |
| 2^{nd} peak | 2.22 kHz | 2.22 kHz | 2.30 kHz | 2.31 kHz |
| 3^{rd} peak | 3.30 kHz | 3.30 kHz | 3.45 kHz | 3.47 kHz |
| 4^{th} peak | 4.50 kHz | 4.69 kHz | 4.76 kHz | 4.73 kHz |
| 5^{th} peak | — | — | 6.00 kHz | 5.99 kHz |

These data support the hypothesis that the sustain frequency at the X and Y electrodes has a dominant influence on the generation of noise. Although one of the respective unit sustain pulses may not create enough force to generate noise by vibrating the substrates, because of capacitive coupling between pairs of sustain electrodes in adjacent cells, several sustain pulses with the same frequencies can act collectively to resonate a panel so that audible noise is generated from the panel.

FIGS. 4A and 4B show examples of a conventional PDP with sustain electrodes that are disposed on an upper plate, wherein the PDP includes X electrodes and Y electrodes extending in a horizontal direction, and address electrodes extending in a vertical direction. Herein, FIG. 4A shows a case with the sustain electrodes arranged in a pattern of X-Y, X-Y, and X-Y, and FIG. 4B shows a case with the sustain electrodes arranged in a pattern of X-Y, Y-X, X-Y, and Y-X. The conventional PDP has continuous regularity as shown in FIGS. 4A and 4B, and the front noise of the panel is increased in such a case.

### SUMMARY OF THE INVENTION

Exemplary embodiments of the present invention are directed to a three-electrode plasma display panel (PDP) with reduced audible noise from the panel. A three-electrode PDP having the features of an exemplary embodiment of the present invention includes a plurality of sustain electrodes and a plurality of address electrodes. The sustain electrodes cross the address electrodes, and the sustain electrodes include a plurality of X electrodes and a plurality of Y electrodes. The sustain electrodes are arranged using at least two of X-Y:X-Y, Y-X:Y-X, X-Y:Y-X, and Y-X:X-Y patterns of four adjacent electrodes.

Another embodiment of the present invention has an arrangement of the sustain electrodes such the pattern of four adjacent electrodes is not repeated more than once.

Yet another exemplary embodiment of the present invention has an arrangement of the sustain electrodes such that sequential patterns of four sustain electrodes alternate between the X-Y:Y-X pattern and the Y-X:X-Y pattern. In this way, within each pattern of four electrodes, the same electrodes are capacitively coupled to each other.

Yet another exemplary embodiment of the present invention has an arrangement of the sustain electrodes such that sequential patterns of four sustain electrodes alternate between the X-Y:X-Y pattern and the Y-X:Y-X pattern. In this way, within each pattern of four electrodes, different electrodes are capacitively coupled to each other.

Yet another exemplary embodiment of the present invention has an arrangement of the sustain electrodes such that sequential patterns of four sustain electrodes alternate between one pattern of four electrodes selected from the group consisting of the X-Y:Y-X pattern and the Y-X:X-Y pattern, and one pattern of four electrodes selected from the group consisting of the X-Y:X-Y pattern and the Y-X:Y-X pattern. In this way, sequential patterns of four electrodes will alternate between having the same electrodes capacitively coupled to each other, and having different electrodes capacitively coupled to each other.

Yet another exemplary embodiment of the present invention has a combination of the X-Y:Y-X pattern and the Y-X:X-Y pattern, and a combination of the X-Y:X-Y pattern and the Y-X:Y-X pattern, continuously arranged in sequence.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, together with the specification, illustrate exemplary embodiments of the present invention, and, together with the description, serve to explain the principles of the present invention.

FIG. 1 is a cross-sectional view showing one cell from a plasma display panel (PDP).

FIG. 2A is a frequency-domain graph of a sustain waveform of a PDP while displaying an NTSC signal.

FIG. 2B is a frequency-domain graph of audible noise from a PDP while displaying an NTSC signal.

FIG. 3A is a frequency-domain graph of a sustain waveform of a PDP while displaying a PAL signal.

FIG. 3B is a frequency-domain graph of audible noise from a PDP while displaying a PAL signal.

FIGS. 4A and 4B show examples of the arrangement of electrodes in a conventional PDP.

FIGS. 5A and 5B show examples of the arrangement of electrodes on a PDP according to exemplary embodiments of the present invention.

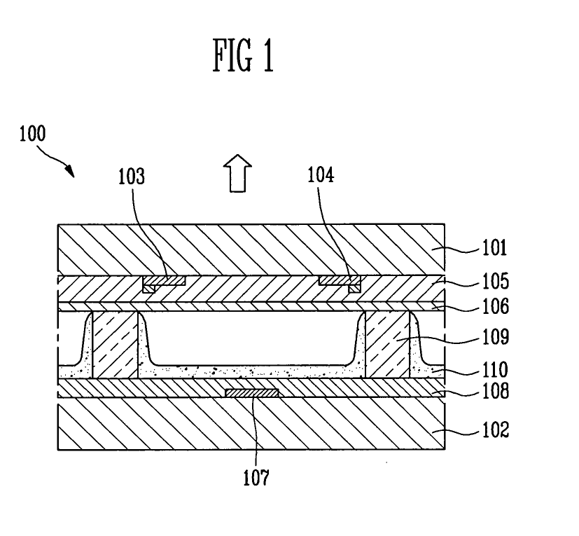

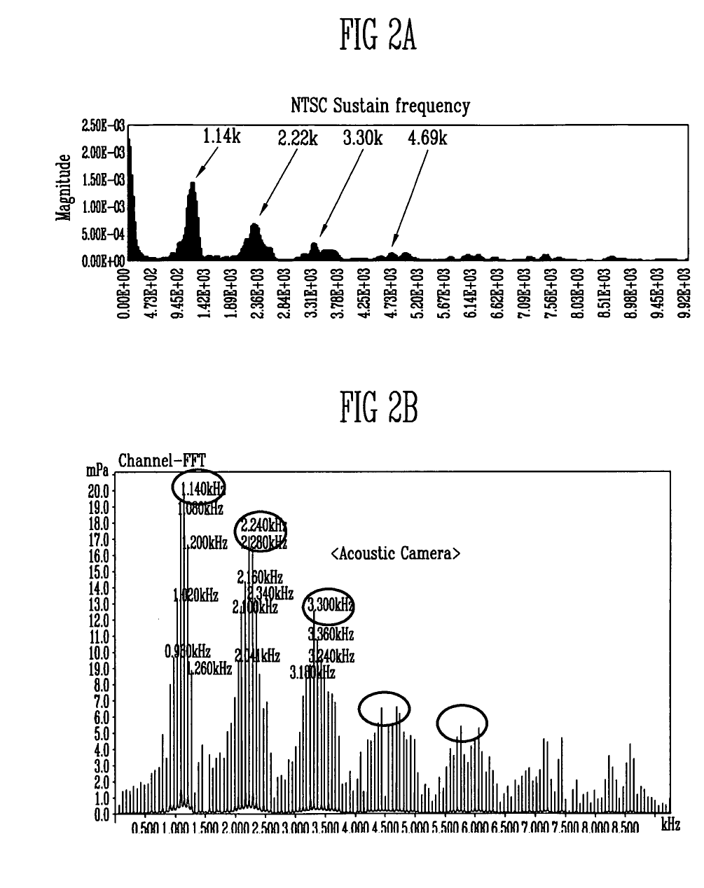

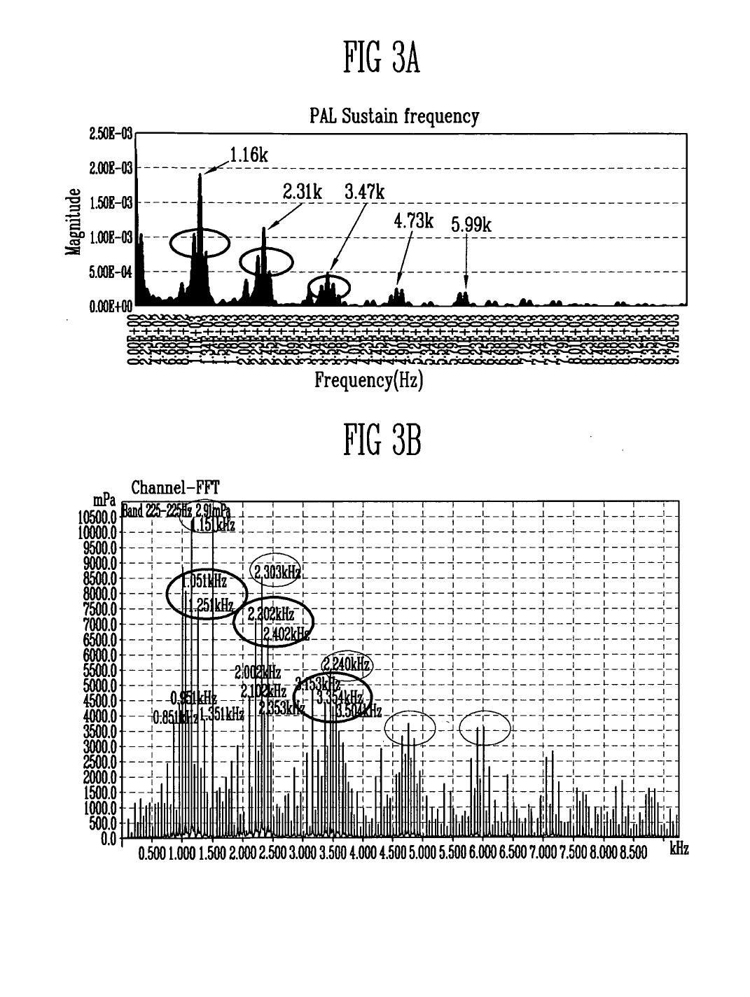

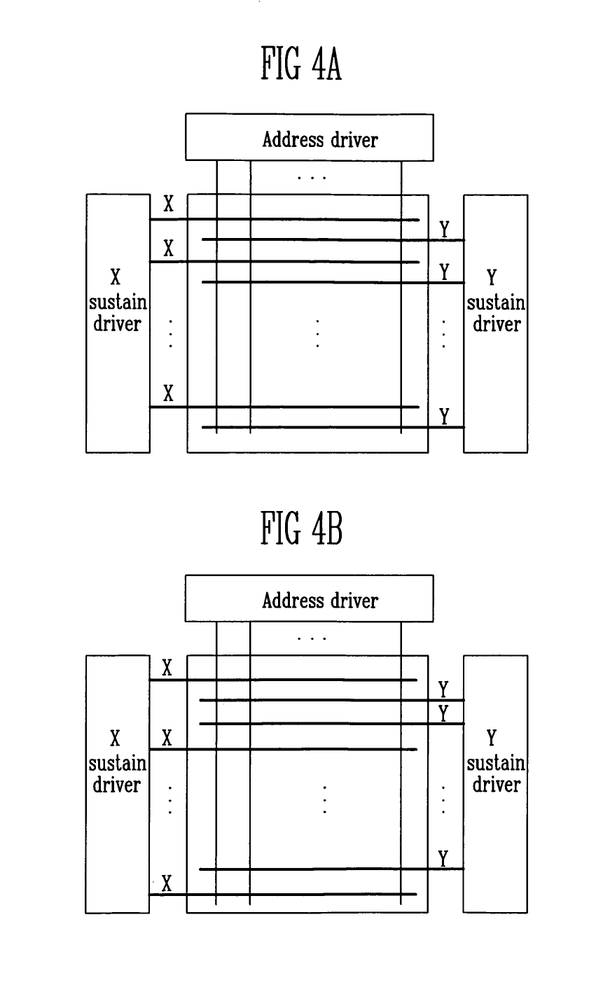

### DETAILED DESCRIPTION OF EXEMPLARY EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “coupled to” another element, it can be directly connected to the other element or be indirectly connected to the other element with one or more intervening elements interposed therebetween. Hereinafter, like reference numerals refer to like elements.

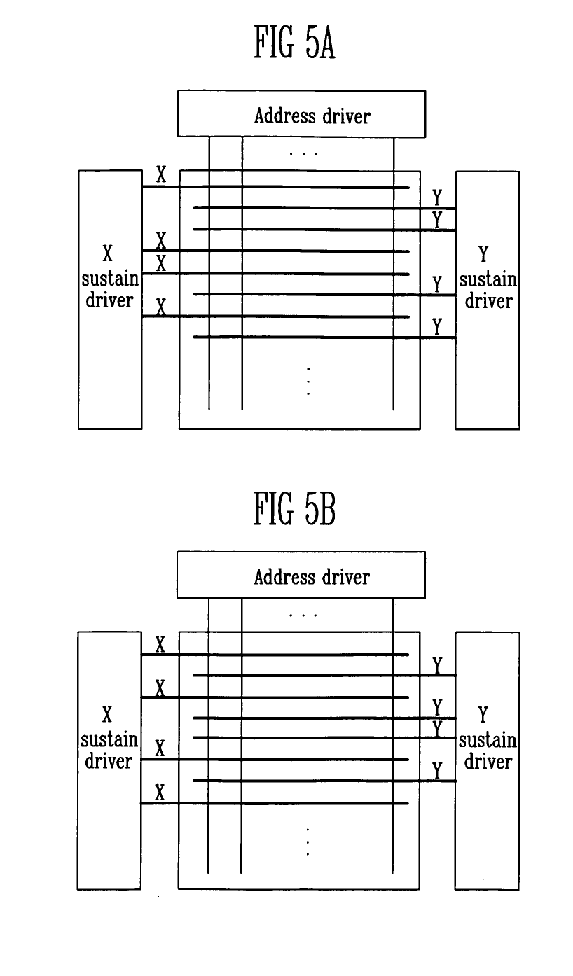

An exemplary embodiment of the present invention is directed to a three-electrode plasma display panel (PDP) for reducing or suppressing resonance between sustain waveforms, which generates audible noise from the front of the PDP, and reducing the noise of the PDP accordingly. FIGS. 5A and 5B are schematic views showing a PDP according to embodiments of the present invention having a plurality of sustain electrodes including X electrodes and Y electrodes, and a plurality of address electrodes. In the illustrated embodiments, the address electrodes extend in a vertical direction and the sustain electrodes extend in a horizontal direction substantially perpendicular to the address electrodes, so that the sustain electrodes cross the address electrodes.

Each PDP cell in the illustrated three-electrode PDP includes the crossing part of an address electrode and an adjacent pair of sustain electrodes (one X electrode and one Y electrode). The pair of sustain electrodes in a particular PDP cell can be arranged so that a first electrode is the X electrode and a second electrode is the Y electrode (X-Y), or the first electrode is the Y electrode and the second electrode is the X electrode (Y-X).

Two cells that are adjacently disposed may have the same pairs of sustain electrodes (X-Y and X-Y, hereafter called X-Y:X-Y for short, or Y-X and Y-X, hereafter called Y-X:Y-X for short), or different pairs of sustain electrodes (X-Y and Y-X, hereafter called X-Y:Y-X for short, or Y-X and X-Y, hereafter called Y-X:X-Y for short). When the two adjacent cells have the same pairs of sustain electrodes, an X electrode from one cell is adjacent to, and capacitively coupled to, a Y electrode from the other cell. When the two adjacent cells have different pairs of sustain electrodes, two X electrodes or two Y electrodes are adjacent to, and capacitively coupled to, one another. Due to capacitive coupling between adjacent pairs of sustain electrodes, continuously repeating patterns of four sustain electrodes may create resonance, resulting in audible noise from the display panel.

According to various embodiments of the present invention, the sustain electrodes are arranged using at least two of the X-Y:X-Y, Y-X:Y-X, X-Y:Y-X, and Y-X:X-Y patterns of four electrodes, such that the same pattern of four electrodes is not repeated more than once.

Such an arrangement where the same pattern of four electrodes is disposed not to be repeated more than once can variously be applied. For example, in one embodiment, two adjacent pairs of sustain electrodes may be arranged with the X-Y:Y-X pattern and the Y-X:X-Y pattern. This way, in each set of four electrodes, the same electrodes (two X electrodes or two Y electrodes) are capacitively coupled to each other.

In another embodiment, the adjacent sets of four sustain electrodes may be arranged with the X-Y:X-Y pattern and the Y-X:Y-X pattern, as in FIG. 5B. This way, in each set of four electrodes, different electrodes (one X and one Y electrode) are capacitively coupled to each other.

In yet another embodiment, the adjacent pairs of sustain electrodes may be arranged with the X-Y:Y-X pattern and the Y-X:Y-X pattern, as in FIG. 5A. This way, each pattern of four electrodes alternately has the same electrodes or different electrodes capacitively coupled to each other.

Other various embodiments are possible. Furthermore, the repetition need not be only with two pairs of four. For example, various patterns using the X-Y:X-Y, X-Y:Y-X, and Y-X:Y-X patterns could be used. Or, an arrangement using all four patterns of four.

With these or other arrangements within the scope of this invention, because regularity in the arrangement of the sustain electrodes occurs at a relatively long interval, it is possible to reduce or remove noise at the front panel by suppressing the resonance caused by capacitive coupling between adjacent pairs of electrodes during the driving of a sustain waveform.

Although a few embodiments of the present invention have been shown and described, it would be appreciated by those skilled in the art that changes might be made in an embodiment without departing from the principles and spirit of the invention, the scope of which is defined in the claims and their equivalents.

What is claimed is:

1. A three-electrode plasma display panel comprising a plurality of sustain electrodes and a plurality of address electrodes crossing the sustain electrodes, the sustain electrodes comprising a plurality of X electrodes and a plurality of Y electrodes, wherein the sustain electrodes are arranged using two or more among patterns of four electrodes, the patterns of four electrodes comprising X-Y:X-Y, Y-X:Y-X, X-Y:Y-X, and Y-X:X-Y patterns.

2. The three-electrode plasma display panel as claimed in claim 1, wherein none of the patterns of four adjacent electrodes is repeated sequentially more than once.

3. The plasma display panel as claimed in claim 2, wherein sequential patterns of four electrodes alternate between the X-Y:Y-X pattern and the Y-X:X-Y pattern.

4. The plasma display panel as claimed in claim 2, wherein sequential patterns of four electrodes alternate between the X-Y:X-Y pattern and the Y-X:Y-X pattern.

5. The plasma display panel as claimed in claim 2, wherein sequential patterns of four electrodes alternate between one pattern of four electrodes selected from the group consisting of the X-Y:Y-X pattern and the Y-X:X-Y pattern, and one pattern of four electrodes selected from the group consisting of the X-Y:X-Y pattern and the Y-X:Y-X pattern.

6. The plasma display panel as claimed in claim 2, wherein a combination of the X-Y:Y-X pattern and the Y-X:X-Y pattern, and a combination of the X-Y:X-Y pattern and the Y-X:Y-X pattern, are continuously arranged in sequence.
